(19) United States
(12) Patent Application Publication
(10) Pub. No.: US 2013/0159215 A1
(43) Pub. Date: Jun. 20, 2013

(54) COMPUTER PROGRAM, METHOD, AND SYSTEM FOR FACILITATING INVESTMENT TRANSACTIONS

(71) Applicant: Think Big Partners, LLC, Kansas City, MO (US)

(72) Inventors: Herbert S. Sih, Mission Hills, KS (US); Christopher Tyler Prochnow, Kansas City, MO (US); Blake Robert Miller, Prairie Village, KS (US)

(73) Assignee: Think Big Partners, LLC, Kansas City, MO (US)

(21) Appl. No.: 13/714,730

(22) Filed: Dec. 14, 2012

Related U.S. Application Data
(60) Provisional application No. 61/570,473, filed on Dec. 14, 2011.

(51) Int. Cl. G06Q 40/06

(52) U.S. Cl. CPC G06Q 40/06
USPC 705/36 R

(57) ABSTRACT

A computer program, method, and system for managing, marketing, and facilitating investment transactions between an entrepreneur, start-up, or early stage company and a potential investor. Investors can research and learn about the companies and the company's business plans. Companies can present information to the investors in a streamlined, efficient manner. Embodiments incentivize investors to commit to funding the companies early, and companies are prevented from “shopping” among investors for more optimal offers or leveraging one investor's interest in the company against another investor. An investment transaction is completed within a known, preset period of time, which further encourages rapid due diligence and closing of the transaction.

### RELATED APPLICATION

This patent application claims priority benefit, with regard to all common subject matter, of earlier-filed U.S. Provisional Patent Application No. 61/570,473, filed Dec. 14, 2011, and entitled “SYSTEM, METHOD, AND COMPUTER PROGRAM FOR FACILITATING INVESTMENT TRANSACTIONS.” The identified earlier-filed provisional patent application is hereby incorporated by reference in its entirety into the present application.

### FIELD

Embodiments of the present invention provide a computer program, method, and system for managing, marketing, and facilitating investment transactions. More particularly, embodiments of the present invention are directed to a computer program, method, and system for presenting investment opportunities to investors while exposing companies seeking investment to the appropriate investors for the company. The present invention encourages quick marrying of the company with the investor while maintaining a fair investment opportunity for the investor and preventing “shopping” by the company.

### BACKGROUND

Entrepreneurs, start-ups, and early stage companies (individually or collectively, “companies”) are commonly striving to attract funds from investors. Often, the company does not know how to locate a qualified investor for the company, and once potential investors are located, the company does not know how to contact, communicate with, and present to the investor in an efficient manner. From the investor's perspective, it must quickly locate and invest in companies that have significant potential value before other investors. This is especially problematic for companies that present attractive investment opportunities; if the investor does not act quickly, it may not have the opportunity to invest at a later date or invest under optimal terms. Additionally, investors have a limited amount of time to research and select potential companies for investing. Moreover, an investor does not want its interest in investing in a particular company to be used as leverage by the company for obtaining more optimal terms from another investor. At the same time, the company wants to obtain as many motivated investors with legitimate funding offers as possible so that the company is not forced to accept unfavorable funding terms. These problems are further exacerbated by the fact that many investors are concentrated in certain geographical areas, and there is a tendency for investors to invest in companies located in these geographical areas.

The marrying of a particular company with a particular investor is not easily performed, however. The fundamental problem is a grossly inefficient capital marketplace in which investors cannot find enough good business plans to fund, and companies cannot find capital to fund their business plans when they need it most and in a time efficient manner. Given this dynamic, there is a need for a computer program, method, and system that matches investors with companies in a streamlined and time sensitive manner.

### SUMMARY

Embodiments of the present invention involve a method and system for facilitating investment transactions by providing an Internet-based environment where entrepreneurs, start-ups, and early stage companies can present and market business plans to potential investors, who can then evaluate and invest in the company in a timely and fair manner. Embodiments of the invention assist companies and investors in three general phases, namely an interest development phase, a live demo and bidding phase, and a due diligence and closing phase.

In the interest development phase, companies post information about their business plans following a structured submission process that may include, for example, submitting a prepared business plan, answering questions about their plans, and submitting a video presentation pitching their plan. The invention assists investors in evaluating the posted business plans and finding plans of interest by, for example, providing search utilities, enabling investors to track particular business plans through watch lists, and automatically generating suggestions for business plans of interest to the investor based on the investor's stated preferences, past funding habits, previous searches, the investor's watch list, etc.

When a particular business plan has reached maturity in the interest development phase, it may enter the second phase comprising a live demo presentation and bidding on the company. Investors who expressed an interest in the business plan during the interest development phase may be invited to participate in the live demo and bidding phase, although the phase is not necessarily restricted to such investors. Investors may participate in the live demo and bidding phase via the Internet to facilitate participation from geographically disperse parties. The live competitive bidding environment encourages early, active participation in the bidding process by providing a financial incentive to investors to participate early. While a large number of interested investors may be invited to participate in the event, for example, only a subset of those investors who are the first to engage in the bidding process may be allowed to invest in the company. Furthermore, the first bidder or bidders may receive a more favorable investment agreement, such as an enhanced equity package, relative to later bidders. Thus, embodiments of the present invention facilitate a fair, streamlined, time-sensitive investment transaction between companies and investors. Moreover, the geographic locations of the parties becomes irrelevant to finding potential respective companies and investors, nor are companies required to relocate to traditionally entrepreneur-friendly locations.

Embodiments of the present invention thus provide a computer program for implementing a method comprising the steps of receiving a completed company profile from a company, wherein the completed company profile includes a prerecorded video that provides a company summary; receiving a completed investor profile from an investor; providing access to the company profile by investors who want to learn and research the company; presenting a first option to each investor for indicating the investor's interest in investing in the company; establishing a minimum threshold of indicated investor interest required for advancing the company to a live presentation; determining if the indicated investor interest meets or exceeds the minimum threshold of indicated investor interest required for advancing the company to a live presentation; presenting a live presentation of the company; subsequent to the live presentation, determining the investors that indicated, in response to a second option, a commitment to invest in the company; and assigning at least some of the investors that responded to the second option a premium investor status that provides the investor with investment advantages over other investors, wherein the premium investor status is based on a premium investor algorithm.

These and other aspects of the invention are illustrated in the exemplary embodiment of the invention set forth below. This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a flow chart of a method of facilitating investment transactions according to embodiments of the present invention; and

FIG. 2 is a schematic depiction of a system for managing investment transactions in accordance with embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for managing, marketing, and facilitating investment transactions. The investment transactions commonly occur between a company, such as an entrepreneur or start-up, seeking outside investor funding, and an investor interested in investing in the company. As used herein, the company seeking an investment may be referred to as the entrepreneur or start-up; however, the terms “company,” “entrepreneur,” “start-up,” and “early-stage” company should be understood to refer to a single person, a team of persons, a registered corporation or company, or the like. Additionally, although embodiments of the present invention are advantageous to start-ups and early-stage companies, it should be appreciated that the present invention may be used with well established companies or companies having significant revenue and growth but that are desiring further investor funding. Thus, reference to entrepreneurs, start-ups, etc. herein is not intended to be limiting.

As commonly occurs between a company and an investor, the investor that invests in a particular company receives a percentage ownership of the company, a seat on the Board of Directors of the company, or some other monetary or non-monetary return on investment. As used herein, an “investment transaction” is any portion of steps or the whole of the steps that occur between a company and an investor in locating and completing an investment opportunity.

The computer program, method, and system of embodiments of the present invention provide an online, electronic resource, such as a website or mobile application, that allows the company to promote and market the company for investment opportunities and that further allows the investor to locate investment opportunities based on criteria established by the investor. Embodiments of the present invention thus manage the interaction between the company and a potential set of investors and promote interest in investing in the company. Upon a minimum number of investors indicating interest in the company during an interest development phase, embodiments of the present invention facilitate a live interaction and bidding process between the company and the investors during a live demo and bidding phase. The present invention encourages fair interaction between companies and investors by limiting the ability of a company to “shop” around for more optimal investment terms, which is advantageous to the investor, while also accelerating the closing of a deal or business relationship between the company and investing investors, which is desirable by both parties. Essentially, companies want committed investors that are willing to close a deal and provide the monetary funds within a short period of time. Investors want to invest in a company without having their interest used as leverage by the company to obtain more optimal terms from another investor, which then leads the first investor to enter into less optimal terms (from the investor's perspective) than originally offered to the company.

The computer program, method, and system of embodiments of the present invention involve a company user, which as noted above may be a single person or a team of persons, and an investor user, which may also be a single person or a team of investors. The present invention may also involve an administrator that implements and administers the method of the present invention. The administrator may establish certain criteria or thresholds, as discussed below, and may further assist the company users and investor users in the investment transactions.

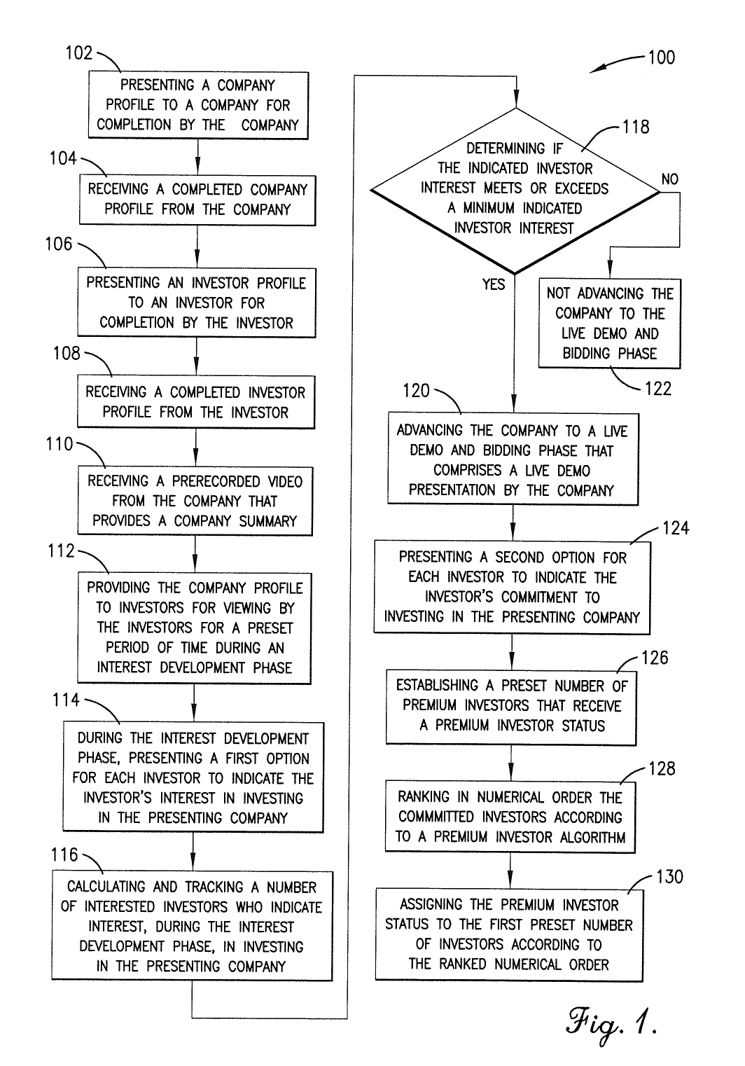

As illustrated in FIG. 1, the computer program of embodiments of the present invention implements or executes the method of other embodiments of the present invention. The method 100 comprises an initial Step 102 of presenting, to a company and for completion by the company, a company profile including a series of questions and requests for information. At Step 104, embodiments of the present invention receive a completed company profile, which encompasses responses to the series of questions and requests for information to the company. The completed company profile identifies at least some attributes of the company. Similarly, at Step 106, the present invention presents, to an investor and for completion by the investor, an investor profile including a series of questions and requests for information, and at Step 108, the invention receives a completed investor profile encompassing responses to the series of questions and requests for information to the investor. The investor profile identifies at least some company attributes the investor desires in companies in which the investor is interested.

At Step 110 embodiments of the present invention receive a prerecorded video from the company, wherein the prerecorded video provides a company summary. The prerecorded video is associated by the computer program of the present invention with the company profile. Upon completion of the company profile, including uploading of the prerecorded video, the company profile is made available for viewing by potential investors for a preset period of time (Step 112), which is referred to as the interest development phase. During the interest development phase while the company profile (or at least portions of the company profile) are available for viewing by potential investors, investors are presented, via a graphical user interface associated with the electronically-accessible resource, a first option for each investor to indicate the investor's interest in investing in the presenting company (Step 114). At Step 116, embodiments of the present invention calculate and track a number of interested investors who indicate interest, during the interest development phase, in investing in the presenting company. Upon determining that the indicated investor interest meets or exceeds a minimum threshold of indicated investor interest (Step 118), the company is progressed to a live and bidding phase that comprises a live demo presentation by the company (Step 120). If the minimum threshold of indicated investor interest is not obtained, the company is not progressed to the live demo and bidding phase, as set forth at Step 122.

Referring to Step 124, during or subsequent to the live presentation, embodiments of the present invention present, via a graphical user interface associated with the electronically-accessible resource, a second option for each investor to indicate the investor's commitment to investing in the presenting company. Embodiments of the present invention establish, at Step 126, a preset number of premium investors that receive a premium investor status, and at Step 128, the present invention ranks the investors who indicated their respective commitment to investing in the present company according to a premium investor algorithm. Finally, at Step 130, embodiments of the present invention assign the premium investor status to the first preset number of investors according to the ranked numerical order. Thus, investors who rank higher according the premium investor algorithm receive the premium investor status, which includes more optimal terms such as more equity ownership of the company, for the same price as investors who rank lower according to the algorithm. Additional steps of embodiments of the present invention include facilitating the due diligence between the company and investing investors and administering the closing of the investment transaction between the company and investing investors, as discussed in more detail below.

The computer program of embodiments of the present invention comprises a plurality of codes segments executable by a computing device for performing the steps of the method of the present invention. The steps of the method may be performed in the order shown in FIG. 1, or they may be performed in a different order. Furthermore, some steps may be performed concurrently as opposed to sequentially. Also, some steps may be optional.

### System Description

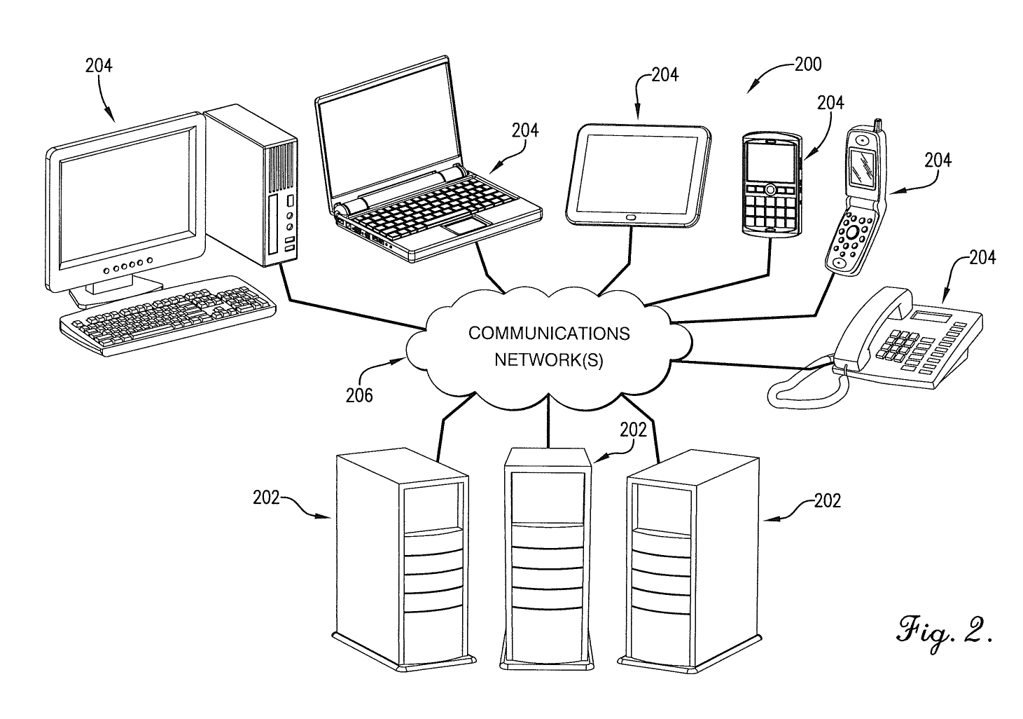

The computer program, system, and method of embodiments of the present invention may be implemented in hardware, software, firmware, or combinations thereof using the investment transaction system 200, shown in FIG. 2, which broadly comprises server devices 202, computing devices 204, and a communications network 206. The server devices 202 may include computing devices that provide access to one or more general computing resources, such as Internet services, electronic mail services, data transfer services, and the like. The server devices 202 may also provide access to a database that stores the company profiles, investor profiles, prerecorded company videos, recordings of live company videos, and other information related to embodiments of the present invention.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores comprising a plurality of hard disk drives, network attached storage, or a separate storage network.

The computing devices 204 may specifically include mobile communication devices (including wireless devices), work stations, desktop computers, laptop computers, palmtop computers, tablet computers, portable digital assistants (PDA), smart phones, and the like, or combinations thereof. Various embodiments of the computing device 204 may also include voice communication devices, such as cell phones or landline phones. In preferred embodiments, the computing device 204 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, discussed in more detail below. In certain embodiments, the computing device 204 may also include an optical device such as a digital camera, video camera, optical canner, or the like, such that the computing device can capture, store, and transmit digital images and/or videos.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks or public switched telephone networks.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection.

The computer program of the present invention may run on computing devices 204 or, alternatively, may run on one or more server devices 202. Thus, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. For example, information related to the company and investor profiles may be stored on a memory element associated with the server device 202, such that the information related to the company and investor profiles is remotely accessible to users of the computer program via one or more computing devices 204. Alternatively, the information related to the company and investor profiles may be directly stored on the memory element associated with the one or more computing devices 204 of the user. In additional embodiments of the present invention, a portion of the information may be stored on the server device 202, while another portion may be stored on the one or more computing devices 204. The various actions and calculations described herein as being performed by or using the computer program may actually be performed by one or more computers, processors, or other computational devices, such as the computing devices 204 and/or server devices 202, independently or cooperatively executing portions of the computer program.

In certain embodiments of the present invention, the computer program may be embodied in a stand-alone program downloaded on a user's computing device 204 or in a web-accessible program that is accessible by the user's computing device 204 via the network 206. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via an electronic resource, such as a mobile “app” or website. For the web-accessible computer program, the user may simply access the computer program via the network 206 (e.g., the Internet) at a URL and with the computing device 204.

### Company and Investor Profiles

Once the user has access to the electronic resource, via the computer program installed on the user's computing device 204 or the web, certain embodiments may provide for users to create accounts with which to access the electronic resource. Via the user accounts, the users may create their respective profiles. The user accounts may be stored within the memory elements of the server 206 or in the associated database. Certain embodiments of the present invention may provide for at least three types of user accounts, including a company account, an investor account, and an administrator account.

The company account is created by or for a company user who may be seeking to obtain investment funds via the computer program and method of the present invention. Via the company account, the company user may create their company profile, which includes company information and a prerecorded company video. In embodiments of the present invention, the company is asked a series of questions and requests for information regarding the company. Exemplary questions include identification of the company (e.g., name, location, size, principals, product or service, market, etc.), amount of investment funds requested, and other relevant information for evaluation by an interested investor. The questions and requested information may vary depending on the type of company and product/service sold by the company, requested investment funds, and other criteria established by the administrator.

The company user may also upload, via the company account, relevant documents (e.g., a business plan or estimated future performance statistics) and the prerecorded video, which is discussed in more detail below. In embodiments of the present invention, the company is required to create a written company portfolio, also known as a “pitch deck,” that sets forth certain information regarding the company, such as a mission statement, principals or personnel associated with the company, a problem solved by the company's provided product/service, how the company's product/service differentiates over competitors' products/services, identification of the relevant market for sale of the company's product/service, identification of the company's competitors, discussion of how the company plans to execute sales of its product/service, current revenue, expected sales projections, and investment goals. The pitch deck will be viewable by investors for educating the investor on the company.

Thus, a company user may make use of various embodiments of the present invention to accept, upload, and complete a company profile. In embodiments of the present invention, completion of the company profile by the company, including uploading of the prerecorded video, is required for advancing the company to the live demo and bidding phase or for allowing the company profile to go “live” or become accessible to other users on the website or other electronic resource.

In further embodiments of the present invention, the company information is normalized based on statistical algorithms for ease of searching and locating by investors of companies meeting the investors' criteria. For example, all companies in a particular market, such as consumer technology cloud products/services, will have the same tag. Embodiments of the present invention may employ multiple tens and hundreds of different tags to identify different attributes of the company. In embodiments, the company may choose tags to self-classify the company. Alternatively, the company may enter its information, and the computer program of the present invention employs algorithms to tag the company based on the entered information. In even further embodiments, the administrator may tag the company. Or, a combination of some or all of self-classify by the company, algorithmic tagging, and tagging by the administrator may be employed.

As discussed in detail below with respect to the investor profile, some investors may wish to invest in certain technologies or services or only with companies having a principal that has successfully founded a prior start-up or that is a serial entrepreneur. Embodiments of the present invention thus tag and normalize the company information to create a searchable database of company attributes. These company attributes may be used by the administrator and investors for identifying companies of interest.

The company and/or the administrator may annotate some or all company information as public, which allows the information to be viewed by any investor or any other user that may access the online resource. Alternatively, the company and/or the administrator may annotate some or all company information as private, which allows only certain users to view the information. As an example, the company may only allow a preferred or preset subset of investors to view some or all of the company profile. Additionally, the company may only allow certain or a limited number of investors the opportunity to indicate their interest in investing in the company during the interest development phase. The company may also have the option of marketing or promoting its company profile to certain investor users. For example, the company may be given the option to send, via the computer program, an invitation to a particular investor to view the company profile.

The prerecorded video preferably sets out basic information regarding the company. In embodiments of the present invention, the prerecorded videos for each company are preferably of a similar format and answer similar questions. This allows serial investors to learn to expect certain types and quality of information from the prerecorded videos and establishes consistent standards for each company in their respective videos. In embodiments of the present invention, the prerecorded videos are approximately seven to nine minutes in length, although they may be shorter or longer depending on criteria established by the company and/or the administrator. The prerecorded videos are part of the company profile, and as such, investors searching for potential companies to invest in may view the prerecorded videos.

Similar to the company account, the investor account is created by or for an investor user who may be seeking to invest in a company via the computer program and method of the present invention. Via the investor account, the investor user may create their investor profile, which includes information regarding the investor for viewing by companies. In embodiments of the present invention, the investor is asked a series of questions and requests for information regarding the investor. Exemplary questions include identification of the investor (e.g., name, location, net worth, interested markets, principals (some investors may comprise a single person or a group or team of persons investing as a single entity), etc.), amount of investment funds the investor normally prefers to invest, whether the investor has previously invested, and other relevant information for evaluation by a company. The answers and requested information may vary depending on the funding size the investor desires to invest, the different markets of interest to the investor, and other criteria established by the administrator.

The investor user may also upload, via the investor account, relevant documents (e.g., information on prior companies in which the investor invested, personal information regarding the investor, etc.) and a personal video. In the personal video, the investor may introduce themselves and provide information regarding their investment preferences, including an investor philosophy, so that a company may learn more regarding the investor.

Thus, an investor user may make use of various embodiments of the present invention to accept, upload, and complete an investor profile. In embodiments of the present invention, investor profiles are searchable by the companies so that the companies may locate investors to which the company wants to particularly market their request for investment funds. In other embodiments of the present invention, investor information in the investor profile is used by the administrator to identify companies that may be of interest to the investor. The computer program of the present invention may learn, via artificial intelligence algorithms or via preset preferences established by the investor, the company attributes preferred by the investor. For example, the investor may, over time using the computer program of the present invention, have a tendency to view company profiles in particular markets or companies having a certain aggregate years of experience. The computer program of the present invention learns this searching and viewing behavior by the investor and suggests to the investor certain companies that may be of interest to the investor based on the investor's stated preferences and prior searching and viewing preferences. Thus, in embodiments of the present invention, all investor activity relative the present invention is performed under the investor account for recording and monitoring by the computer program and administrator of the present invention.

The administrator account is created by or for an administrator user who manages the computer program of embodiments of the present invention. The administrator account may be used to create, author, and present the series of questions and requests for information to the companies and investors, establish minimum threshold values for investor interest during the interest development phase and rank and establish premium investor status to investors during presentation of the live presentation by the company. As can be appreciated, the administrator account may have administrator access and control to various portals and databases of the present invention and as may further be described below.

Although certain details and descriptions provided below discuss certain functions, features, and/or implementations of the present invention being carried out by a particular type of user or user account, it is hereby understood that such descriptions are simply provided for illustrative purposes. All information entered by the various users of embodiments of the present invention is received, via the network 206, and may be stored on the server device 202 or associated databases.

Although certain embodiments of the present invention may require a user to establish an account, certain other embodiments may provide for certain features of the present invention to be utilized, such as browsing the company profiles, without requiring the establishment of a user account. For instance, a potential investor may be able access the online resource, such as an online website, and browse the company profiles without needing to register or create an account.

Embodiments of the present invention also include a search engine for searching for company and investor profiles by the respective company and investor users. The search engine is operable to access the database of company and investor profiles, including the tagged or normalized data, and locate companies and investors based on the entered search terms or criteria. The search engine may employ known searching algorithms to perform the searching. In the case of investors searching for companies, the search engine may operate to search for companies having company attributes the investor identified as desirable in the investor profile. In this case, the computer program of the present invention presents a graphical user interface to the investor that allows the investor to perform a search without having to enter any company attributes but instead pulling desirable company attributes from the investor profile. The investor may also be given, at the time of the search, an option to add or delete company attributes for performing the particular search. Alternatively, the search engine may allow for the investor to input the company attributes of interest for that particular search and not pull company attributes from the investor profile.

In even further embodiments of the present invention, each company user and investor user may see data and statistics on who has viewed their respective profiles. Additionally, the company and investor users may generate reports setting forth desired information and historical analyses. For example, a company may want to generate a report of the number or identity of investors who have viewed the company profile and an average funding of each investor.

### Interest Development Phase

After a company has completed a company profile, the company then advances to the interest development phase. As its name suggests, during this phase, the company develops investor interest in the company and must obtain a minimum threshold of investor interest to advance the company to the live demo and bidding phase. The investor interest may be established based on a variety of criteria and factors, and the minimum threshold of investor interest may be different for each company. For example, in some embodiments of the present invention, the minimum threshold of investor interest may be measured by the number of investors that indicate an interest in investing in the company. Under this example, if the minimum threshold of investor interest is set at ten investors, then ten investors must indicate their interest in investing in the company before the company can advance to the live demo and bidding phase. In other embodiments of the present invention, the minimum threshold of investor interest may be measured by an aggregate amount of funding one or more investors would be willing to invest in the company. Under this example, if the minimum threshold of investor interest is one million dollars, then each interested investor would be requested to enter the amount the investor would be willing to invest (note that this is not necessarily a request for a commitment by the investor to fund the company but rather a potential funding amount to gauge investor interest). When the aggregate entered amount meets or exceeds one million dollars, the company is advanced to the live demo and bidding phase. In yet other embodiments of the present invention, the minimum threshold of investor interest may be a combination of a number of investors, an amount of funding indicated by the investors as willing to invest, and other factors. For ease of reference and as further described herein, the minimum investor interest is a threshold number of investors interested in investing in the company after viewing of the company's profile. The administrator establishes the minimum investor interest, e.g., the minimum number of investors required to advance the company to the next phase. Alternatively, the company establishes the minimum investor interest or otherwise may override the administrator's established minimums.

In embodiments of the present invention, the interest development phase extends for a preset period of time, such as a few days to a few weeks, and in some embodiments of the present invention, the interest development phase extends for one month, two weeks, one week, five days, three days, or one day. As noted above, the phase does not begin until the company profile is complete. However, the administrator, potentially in conference with the company, may choose to delay beginning the interest development phase or may choose to schedule a particular time period for the phase. For example, the company may complete its company profile but not actually begin the interest development phase for a few weeks or months thereafter.

Upon commencement of the interest development phase, the company profile, or portions thereof, is available for viewing by at least a portion of the investor users, based on whether the company or administrator has placed any viewing restrictions on the company profile. Also during all or a portion of this phase, the computer program of the present invention presents, via the graphical user interface, a first option for an investor to indicate the investor's interest in investing in the company. In embodiments of the present invention, the first option may simply be the investor selecting or answering yes to the question of would the investor be willing to invest. In other embodiments of the present invention, the first option may ask the investor if it would be willing to invest a certain amount of money or under what terms or different company attributes would the investor be willing to invest. The investor may access the first option to select interest in a particular company via the investor account, and in embodiments of the present invention, the first option is presented via the graphical user interface that also presents the company profile. The first option for indicating investor interest is presented for only a preset period of time, and it may be presented for a period of time coinciding with the time period for the interest development phase or for a period of time less than the interest development phase. For example, the interest development phase may extend for two weeks, but the first option is presented via the electronic resource for selection by investors for only a subset of the two-week time period. The administrator and/or company may further decide the preset time period for presenting the first option.

The present invention monitors and calculates the indicated investor interest, and upon determining that the indicated investor interest meets or exceeds the minimum threshold of investor interest, the interest development phase is completed and the company is advanced to the live demo and bidding phase for funding. The computer program of the present invention notifies the administrator, the company, the investors who indicated an interest in the company, and the investors who are “watching” or otherwise tracking the company that the minimum threshold of investor interest is met. The present invention may also inform some or all of the above-listed parties of the live demo and bidding phase, including the live presentation. In contrast, if the minimum threshold of investor interest is not met during the interest development phase, the company is not advanced to the live demo and bidding phase. Instead, the company may undergo training or education by the administrator to address reasons why the minimum threshold of investor interest was not met.

To prevent investor “shopping” by a company and to insure an equal and fair opportunity for each investor to invest in a particular company, the identities of the investors that indicated an interest in investing in the company are not provided to the company during the interest development phase. In alternative embodiments, the identities of interested investors are not provided to the company after completion of the interest development phase or even after closing of the investment transaction. This prevents the company from being able to contact an investor outside the confines of the present invention, which may be viewed as placing one investor in a more favorable position than other investors. Alternatively, after completion of the investment transaction or at a time prior established by the administrator, an identity of each investor that has either reviewed the company profile for the company or that has indicated an interest in investing in the company is made available for viewing by the company. The identities of the investors interested in investing in the company are known to the administrator, and in embodiments of the present invention, the administrator and investors may contact each other and communicate about the company should the need arise.

Because the interest development phase is held over a few days to few weeks period, investors are given sufficient time to review the company profile, perform any desired research on the company or market, and determine if the investor is willing to invest in the company. Also during the interest development phase, investors may submit questions and requests for further information to the company. The questions and requests may be submitted either directly to the company or be submitted to the administrator, who then in turn submits to the company.

The investor may, via the investor account, select companies to watch or monitor during the companies' respective interest development phases. The investor may also set requests for various alerts to be sent to the investor via the computer program of the present invention. For example, the investor may request an alert when another investor has indicated interest in the company, a time remaining for the interest development phase for the companies on the particular investor's watch list, or when a minimum threshold of investor interest is reached for a particular company.

As briefly noted above, the administrator of embodiments of the present invention may send notices to investors advising of the beginning of or ongoing investor interest development phase for particular companies and encouraging the investors to visit the company profiles via the electronic resource. The administrator may also select companies to highlight, such as at a main page of the website or electronic resource, or the computer program of the present invention may identify at the main page companies that are trending or that are receiving the most views of their company profiles. The administrator may further perform its own research on the company and assign a score or grade to the company that investors can use to evaluate the company. The administrator may also enter comments about the company viewable by investors, such as identifying that the company has principals with past prior start-up success.

In embodiments of the present invention, the administrator may also collects statistics on the company during the interest development phase, such as which investors view a company profile, the length of time viewed by the investor, the documents opened by the investor, suggestions or questions submitted by the investor, etc. The administrator may then collect and analyze this information to use for educating the company on how to increase funding likelihood.

### Live Demo and Bidding Phase

The live demo and bidding phase occurs preferably several days after completion of the interest development phase to allow the company to prepare for the live presentation. The live demo and bidding phase is, as the name suggests, the phase wherein the company presents a live demonstration or “pitch” and the investors bid on the opportunity to actually invest in the company. Thus, unlike the interest development phase that seeks only investor interest, the live demo and bidding phase seeks investor commitment to invest in the company.

The live presentation is preferably held at least eight days and no more than two weeks after completion of the interest development phase. This time frame allows sufficient time for the company to prepare for the live presentation while still being short enough to maintain investor interest. However, it should be appreciated that the live presentation may be scheduled sooner before or later after completion of the interest development phase. For example, the live presentation may be scheduled for at least three days and no longer than thirty days from the completion of the interest development phase. Live presentations for particular markets or industries (or for particular size companies or companies seeking certain amounts of funding) are preferably held at the same time and on the same day of the week or month every recurring period so that investors learn to schedule watching of the live presentations for companies in the markets preferred by the investor.

The live presentation is an opportunity for the investors to see the personnel involved with the company live, not prerecorded, and not staged. It is also an opportunity for the company to present its business plan to the investors under the pressure of being live and not having the opportunity to correct any errors in the presentation. Additionally, the live presentation is an opportunity for the investors to submit questions to the company for answering by the company “on the fly.” In embodiments of the present invention, the company does not receive the investors' questions prior to the live presentation, and as such, the investors receive an unfiltered view of the company personnel answering the questions. This allows the investors to better evaluate the personnel involved with the company, which is especially desirable by investors.

The live presentation is preferably about thirty minutes long, although it could be shorter or longer. Approximately ten minutes of the thirty-minute length is spent with the company personnel introducing the company and salient information about the company, referred to as the “pitch.” Although basic information regarding the company may be introduced during the pitch, it should be appreciated that every company will present differently. However, the administrator of the present invention may establish certain items of information that the company personnel should present during the pitch or a set format for the pitch to insure consistent and basic information regarding companies is always presented during their respective pitches. This consistency in company pitches insures that the present invention maintains a certain standard and quality that can be expected by investors. In embodiments of the present invention, the company presents its pitch at a professional recording studio or location so that the pitch videos have a consistent and professional quality across the various companies.

Approximately twenty minutes of the thirty minute live presentation is spent in a question and answer session with the company. As noted above, investors may submit questions via the computer program of the present invention for asking of the company personnel during the live presentation. The administrator may also ask their own questions or may ask first those questions that were more often submitted by the investors. Alternatively, the investors may ask the questions of the company personnel.

The live presentation is preferably streamed or otherwise communicated to the investors in real time and via the communications network, such that the investors can access the live presentation via the electronic resource. At the graphical user interface located at the electronic resource, the streaming video of the presentation is presented. Additionally, the investor may further view the company profile, including the company's pitch deck, company attributes, and the company's prerecorded video, which may be presented within the same graphical user interface as the streaming live video. Essentially, all company information available to the investor for evaluating the company will be presented via the computer program of the present invention and accessible by the investor at the electronic resource.

Immediately or soon after conclusion of the live presentation, a second option for each investor to indicate their commitment to invest in the company, i.e., bid on the opportunity to invest in the company, is presented via the graphical user interface associated with the electronic resource. (It should be appreciated that use of the term “second option” is to contrast the option to indicate the investor's commitment to investing, presented during the live demo and bidding stage, versus the first option, presented during the investor interest phase, of indicating the investor's interest in investing). The second option requesting the user to indicate their commitment to invest may include a link to the terms and conditions for investment, including a requested funding amount, the equity percentage received in turn, a time for when funding is expected, and other investment conditions. In some embodiments of the present invention, the second option and accompanying terms and conditions presented to the investors may be a single option. In other words, the second option presented to the investor may be “Select here if you commit $500,000 to this company within 60 days.” Alternatively, the second option may present several sub-options from which each investor may select, such as (1) “Select here if you commit $500,000 to this company within 30 days”; (2) “Select here if you commit $1 Million to this company within 60 days”; or (3) “Select here if you commit $1.5 Million to this company within 90 days.” As discussed below, an investor's commitment to more money or money within a shorter period of time than other investors may factor into the ranking of the investor.

In embodiments of the present invention, the second option may not be presented to the investor via the graphical user interface until after completion of the live presentation. In some embodiments, it may be presented immediately after completion of the live presentation, such as within a few seconds to a few minutes after completion. Alternatively, the second option may be presented at a specified period of time after completion of the live presentation. In embodiments, the second option for each company is always presented at the same time period after completion of the live presentation to establish consistent expectations by investors on when the second option to indicate a commitment to fund will be available for selection. In yet further embodiments, the second option may be presented before or immediately upon the live presentation beginning. Certain advantages are obtained by having the second option presented for selection by the investors immediately or within a few minutes of completion of the live presentation. Such advantages include insuring investor interest in the company is high and has not had time to be lessened and further insuring that investors cannot contact or communicate with the presenting company so as to gain an advantage over other investors.

As noted above, certain investors that indicate a commitment to invest in the company in response to the second option will be assigned a premium investor status. The premium investor status will have advantages over other funding investors, such as a higher equity ownership for the same amount of funding investment. However, it should be appreciated that the premium investor status may have varying features or advantages as established by the company and/or the administrator. In some embodiments of the present invention, the advantages and features commensurate with the premium investor status will be the same for every investor awarded premium investor status. In other embodiments, a certain number of the investors awarded premium investor status may receive different features or advantages than other investors awarded premium investor status.

In embodiments of the present invention, the administrator and/or company establishes a premium investor number that equates or corresponds with the number of committed investors that will receive premium investor status. For example, if the administrator and/or company decide that the premium investor number will be three investors, then three investors that indicate their commitment to invest in the company in response to the second option will receive the premium investor status. An exemplary factor that may be considered when determining the premium investor number include the advantages accorded premium investor status and whether the amount of awarded advantages are financially acceptable to the company for a particular premium investor number.

Embodiments of the present invention rank the investors who indicated their respective commitment to investing in the presenting company according to a premium investor algorithm. Continuing with the example provided above, for the first three investors ranked according to the premium investor algorithm, those investors will receive the premium investor status. In embodiments of the present invention, the premium investor algorithm is an identification of the chronological order in which the investors selected the second option, i.e., the chronological order in which the investors indicated their commitment to invest in the company or “bid” on the company. As can be appreciated, such a premium investor algorithm encourages immediate and fast commitment by the investors and essentially awards the earlier-in-time investors who indicate their commitment over the later-in-time investors who indicate their commitment. In such an embodiment, the computer program of the present invention tracks and records the chronological order the investors select the second option via their respective graphical user interfaces at the electronic resource.

In alternative embodiments of the present invention, the premium investor algorithm is more complicated and analyzes more factors in determining the ranking for the investors. For example, the algorithm may use as a factor whether the investor indicated an interest in investing in the company in response to the first option presented during the interest development phase. As noted above, another factor may be the amount of money a particular investor is willing to commit for investing in the company or a length of time by which the investor will provide the funds. Other factors include whether the investor has previously invested via the present invention, a committed funding level by the investor, the investor's experience in investing in successful companies as tracked by the computer program of the present invention, whether the presenting company is in a market the investor has experience in or previously indicated an interest in, etc.

Once the investors are ranked according to the premium investor algorithm, the premium investor status is assigned to the number of investors corresponding to the premium investor number and according to the ranked numerical order. In other words, after the investors are ranked in numerical order, if the premium investor number is three, then the premium investor status is assigned to the first three investors.

Investors who bid or otherwise indicate their commitment to invest in the company but that are not assigned premium investor status are also ranked according to the embodiments described above. For example, if the investors are ranked in the chronological order in which they indicated their bid, then the investors are given the opportunity to invest in the company, i.e., become funding investors, in the ranked, chronological order until further investment funds from investors are not required. As an example, if the company is a very attractive company for investing to the potential investors, then more investors than necessary for supplying the desired goal of investment funds may indicate their commitment to investing in the company. As such, the computer program of the present invention determines the order in which the investors indicated their commitment, i.e., responded to the second option. Once the order is determined, the computer program of the present invention determines the investors that are assigned as funding investors, i.e., their indicated commitment and rank results in them being selected to fund the investment. Thus, the investors are assigned as funding investors in the order they responded until the funding goal is met. This encourages each investor to quickly respond to the second option to show the investor's commitment to investing in the company. In embodiments of the present invention, investors who are not assigned as funding investors are not identified to the company.

### Due Diligence and Closing Phase

After completion of the live demo and bidding phase, the investors committed to investing the company and selected based on the ranking (i.e., the funding investors) are identified to the company. The funding investors and the company then begin the process of due diligence, in which the company supplies the investors any additional information required to complete the investment transaction, the parties enter into the necessary contractual agreements to complete the funding, etc. During this time the parties are incentivized to close the investment transaction within a particular period of time after the live demo presentation. In particular, in embodiments of the present invention, the computer program supplies benchmarks to the parties to complete the investment transaction within thirty to ninety days after the live demo presentation. The administrator of the present invention may facilitate the closing of the transaction, including answering any questions the parties may have, being a liaison between the parties, insuring each party is meeting their respective benchmarks for the due diligence process, etc.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium with an executable program stored thereon for facilitating investment transactions, wherein the program instructs a processor to perform the following steps:
provide a series of questions and requests for information to a company for completion by the company;
receive responses to the series of questions and requests for information to the company, wherein the company's responses are aggregated as a company profile and wherein the company profile identifies at least some company attributes;
provide a series of questions and requests for information to an investor for completion by the investor;
receive responses to the series of questions and requests for information to the investor, wherein the investor's responses are aggregated as an investor profile and wherein the investor profile identifies at least some company attributes the investor desires in companies in which the investor is interested in investing;
instruct the company to submit a prerecorded video that provides a company summary, wherein the prerecorded video is associated with the company profile;
provide electronic access by at least one investor, via an electronically-accessible resource and for only a first preset period of time, to at least a portion of the company profile and the prerecorded video for viewing by the at least one investor;
present, via a graphical user interface associated with the electronically-accessible resource, a first option for each investor to indicate the investor's interest in investing in the presenting company,
wherein the first option for each investor to indicate the investor's interest is presented for a second preset period of time;
determine an indicated investor interest that is at least in part based on the investors' responses to the first option;
establish a minimum threshold of investor interest required for advancing the company to a live presentation;
determine if the indicated investor interest meets or exceeds the minimum threshold of investor interest required for advancing the company to a live presentation;
if the indicated investor interest meets or exceeds the minimum threshold, present, via the electronically-accessible resource, a live presentation of the company,
wherein the live presentation is a live video of personnel associated with the company, and during the live presentation, the personnel associated with the company answer at least one question presented by an administrator or an investor;
during or subsequent to the live presentation, present, via a graphical user interface associated with the electronically-accessible resource, a second option for each investor to indicate the investor's commitment to investing in the presenting company;
establish a preset number of premium investors that receive premium investor status;
rank the investors in numerical order who indicated their respective commitment to investing in the present company according to a premium investor algorithm; and
assign the premium investor status to the first preset number of investors according to the ranked numerical order.

2. The computer readable medium of claim 1, wherein the program is further operable to instruct the processor to provide a search engine that allows potential investors to identify company attributes desirable to the investor and to perform a search for companies with such company attributes.

3. The computer readable medium of claim 2, wherein the company attributes identified by the potential investors for performing the search are identified in response to the questions and requests for information presented to the investor for the investor profile, and the search engine pulls the company attributes from the investor profile for performing the search.

4. The computer readable medium of claim 2, wherein the company attributes identified by the potential investors are identified at the time when the investor performs the search, via the search engine, for companies having particular company attributes.

5. The computer readable medium of claim 1, wherein the company profile includes a name of the company, a name of at least one principal associated with the company, an amount of investment funding sought, a market for the company, identification of whether a principal in the company has previously founded or participated in a start-up or early-stage company, and an experience level of at least one principal of the company.

6. The computer readable medium of claim 1, wherein the minimum threshold of investor interest is selected from the group consisting of: a minimum dollar amount that an aggregate one or more investors indicated interest in investing in the presenting company, and a minimum number of investors that indicated interest in investing in the presenting company.

7. The computer readable medium of claim 1, wherein the minimum threshold of investor interest required for advancing the company to a live presentation is established by an administrator or by the presenting company.

8. The computer readable medium of claim 1, wherein after expiration of the second preset period of time for presenting the first option for each investor to indicate the investor's interest, the investors can no longer indicate their interest in investing in the presenting company.

9. The computer readable medium of claim 1, wherein the indicated investor interest in response to the first option includes identifying a funding level that the investor desires to invest in the company.

10. The computer readable medium of claim 1, wherein the investor may only indicate the investor's interest in investing in the presenting company in response to the first option upon reviewing at least a portion of the company profile.

11. The computer readable medium of claim 1, wherein each company is assigned or selects at least one market applicable to the company, and live presentations for particular markets are scheduled for the same time each week or month.

12. The computer readable medium of claim 1, wherein the live presentation is scheduled for at least three days and no longer than thirty days from the company presentation.

13. The computer readable medium of claim 1, wherein the second preset time period is less than the first preset time period.

14. The computer readable medium of claim 1, wherein the premium investor status includes terms and conditions, and the terms and conditions for at least one of the investors assigned the premium investor status is different than the terms and conditions for the other investors assigned the premium investor status.

15. The computer readable medium of claim 1, wherein the premium investor algorithm is a ranking of the chronological order in which each investor responded to the second option indicating their respective commitment to invest in the company.

16. A method of facilitating investment transactions comprising the steps of:
providing, via a graphical user interface associated with an electronically-accessible resource, a series of questions and requests for information to a company for completion by the company;
receiving, via a graphical user interface, responses to the series of questions and requests for information to the company, wherein the company's responses are aggregated as a company profile and wherein the company profile identifies at least some company attributes;
providing, via a graphical user interface associated with the electronically-accessible resource , a series of questions and requests for information to an investor for completion by the investor;
receiving, via a graphical user interface, responses to the series of questions and requests for information to the investor, wherein the investor's responses are aggregated as an investor profile and wherein the investor profile identifies at least some company attributes the investor desires in companies in which the investor is interested in investing;
instructing the company to submit a prerecorded video that provides a company summary, wherein the prerecorded video is associated with the company profile;
providing access by at least one investor, via the electronically-accessible resource and for only a first preset period of time, to at least a portion of the company profile and the prerecorded video for viewing by the at least one investor;
presenting, via a graphical user interface associated with the electronically-accessible resource, a first option for each investor to indicate the investor's interest in investing in the presenting company,
wherein the first option for each investor to indicate the investor's interest is presented for a second preset period of time;
determining, via a processor, an indicated investor interest that is at least in part based on the investor's response to the first option;
establishing a minimum threshold of investor interest required for advancing the company to a live presentation;
determining if the indicated investor interest meets or exceeds the minimum threshold of investor interest required for advancing the company to a live presentation;
if the indicated investor interest meets or exceeds the minimum threshold, presenting, via the electronically-accessible resource, a live presentation of the company,
wherein the live presentation is a live video of personnel associated with the company, and during the live presentation, the personnel associated with the company answer at least one question presented by an administrator or an investor;
during or subsequent to the live presentation, presenting, via a graphical user interface associated with the electronically-accessible resource, a second option for each investor to indicate the investor's commitment to investing in the presenting company;
establishing a preset number of premium investors that receive premium investor status;
ranking, via a processor, the investors in numerical order who indicated their respective commitment to investing in the present company according to a premium investor algorithm; and
assigning the premium investor status to the first preset number of investors according to the ranked numerical order.

17. The method of claim 16, wherein the minimum threshold of investor interest is selected from the group consisting of: a minimum dollar amount that an aggregate one or more investors indicated interest in investing in the presenting company, and a minimum number of investors that indicated interest in investing in the presenting company.

18. The method of claim 16, wherein the second preset time period is less than the first preset time period.

19. The method of claim 16, wherein the premium investor status includes terms and conditions, and the terms and conditions for at least one of the investors assigned the premium investor status is different than the terms and conditions for the other investors assigned the premium investor status.

20. The method of claim 16, wherein the premium investor algorithm is a ranking of the chronological order in which each investor responded to the second option indicating their respective commitment to invest in the company.
